(19) United States
(12) Patent Application Publication
(10) Pub. No.: US 2005/0133451 A1
(43) Pub. Date: Jun. 23, 2005

(54) A FULL-FLOW MICROFILTRATION DEVICE AND METHOD FOR FILTERING FLUIDS

(75) Inventors: Pierre Gerard Willem Nieuwland, 6451 EL-Schinveld (NL); Ron Borger, 3146 B A Maasluis (NL)

Correspondence Address: ARTZ & ARTZ, P.C., 28333 TELEGRAPH RD., SUITE 250, SOUTHFIELD, MI, 48034, US

(73) Assignee: NTZ NEDERLAND BV, Rotterdam (NL)

(21) Appl. No.: 10/905,212

(22) Filed: Dec. 21, 2004

Related U.S. Application Data
(60) Provisional application No. 60/532,077, filed on Dec. 23, 2003.

(51) Int. Cl. B01D 61/00

(52) U.S. Cl. 210/650; 210/137; 210/321.87; 210/456

(57) ABSTRACT

A full-flow microfiltration device (12) and method for filtering fluid in a hydraulic system (10) is provided. The filtration device (12) includes a housing (22) and a filter medium (24) sealingly coupled to and contained within the housing (22). The housing (22) and the filter medium (24) define a central chamber (26) and a concentric chamber (28). The central chamber (26) directly communicates with an entry port (34) and an exit port (36) formed within the housing (22) for directing a first flow through the filter device (12). The concentric chamber (28) directly communicates with an inlet port (38) and an outlet port (40) formed within the housing (22) for directing a second flow through the filter device (12). A portion of the second flow is drawn from the concentric chamber (28) through the filter medium (24) into the central chamber (26) and into the first flow.

### CROSS-REFERENCE TO RELATED APPLICATIONS

This application claims the benefit of U.S. Provisional Application No. 60/532,077, entitled “BYPASS FILTER AND METHOD OF FILTERING” and filed on Dec. 23, 2003.

### TECHNICAL FIELD

The present invention relates generally to filter devices, and more particularly to a full-flow microfiltration device and method for filtering fluid in a hydraulic system.

### BACKGROUND

It is well known that solid-particle contamination can damage automotive transmission systems. Two common types of contamination include Type I contamination and to a greater extent Type II contamination.

Type I contamination usually comprises substantially large particles having diameters larger than about 150 microns. These particles can include remnants from the manufacturing processes utilized for building the transmission systems. This contamination can rapidly damage the systems and lead to early-life repairs.

Also, the more abundant Type II contamination usually includes particles having diameters less than about 60 microns. These particles can be debris generated from component wear, as well as particles ground up from larger Type I particles. This contamination can cause erratic valve performance, poor cooling, inefficient lubrication, and accelerated degradation of automatic transmission fluid (ATF), all of which promote mid-life transmission failures.

The Type II particles, which have diameters roughly within the 40 to 60 micron range, usually are removed from the ATF by coarse full-flow filters. These coarse filters typically have substantially low flow resistance.

Additionally, the Type II particles, which have diameters less than about 40 microns, can be removed from the ATF by microfiltration devices. It is understood that this fiber material is sufficiently fine for filtering the small Type II particles from the ATF. For this reason, the microfiltration device typically has high flow resistance and only allows about ten percent of the ATF to pass therethrough. In that regard, the microfiltration device typically is integrated within the transmission system in a parallel configuration with respect to a main flow of the ATF. In this way, the transmission system typically requires additional tubing for providing the parallel attachment of the microfiltration device.

Furthermore, the microfiltration devices each typically include a rigid housing and a filter cartridge that is clamped between the opposing ends of the housing. The filter cartridge usually is made of a fine, substantially deformable fiber material. Examples of this fiber material can include paper-like materials, felt-like materials, and glass-fiber materials.

Additionally, the fiber material's high resistance to flow creates a high pressure differential from an inlet surface to an outlet surface of the fiber material. This pressure differential typically is sufficiently high for compressing the deformable fiber material in a transverse direction thereby increasing the filter cartridge's axial length. On the other hand, when the flow is halted, the fiber material can decompress and expand transversely so as to shorten the filter cartridge's axial length. These slight changes in the filter cartridge's length can create a transient gap between the opposing end faces of the filter cartridge and the rigid housing. This gap can allow ATF to circumvent the filter cartridge and pass through the microfiltration device without being cleaned. Such a result clearly is undesirable.

It would therefore be desirable to provide a full-flow microfiltration device that does not require additional tubing and can more efficiently filter fluid despite changes in length of the filter cartridge when flow through the microfiltration device is commenced, halted, or otherwise changed.

### SUMMARY OF THE INVENTION

The present invention provides a full-flow microfiltration device and method for filtering fluid in a hydraulic system. The device includes a housing and a filter medium sealingly coupled to and contained within the housing. The housing and the filter medium define a central chamber and a concentric chamber. The central chamber directly communicates with an entry port and an exit port formed within the housing for directing a first main flow through the filter device. The concentric chamber directly communicates with an inlet port and an outlet port formed within the housing for directing a second main flow through the filter device. A portion of the second main flow is drawn from the concentric chamber through the filter medium into the central chamber and into the first main flow.

One advantage of the present invention is that a microfiltration device is provided that can be integrated within full-flow lines so as to dispense with the need for a parallel configuration, as well as the additional tubings, couplings, labor, time, and costs associated therewith.

Another advantage of the present invention is that a microfiltration device for a hydraulic system is provided that decreases the number of components of the hydraulic system and increases the available space within an engine compartment.

Yet another advantage of the present invention is that a microfiltration device for a hydraulic system is provided that can decrease leakage around a filter medium and improve fluid purity.

Still another advantage of the present invention is that a microfiltration device for a hydraulic system is provided that can provide a substantial pressure differential across a filter medium for drawing an increased amount of fluid through the filter medium.

Yet another advantage of the present invention is that a microfiltration device for an automatic transmission hydraulic system is provided that can improve general transmission durability, shift timing, and shift feel.

Still another advantage of the present invention is that a microfiltration device for an automatic transmission hydraulic system is provided that can remove contaminants from the lubricant so as to decrease clutch and band deterioration, as well as wear on bearings.

Yet another advantage of the present invention is that a microfiltration device for an automatic transmission hydraulic system is provided that can substantially decrease the amount of copper and iron debris in the automatic transmission fluid (ATF) thereby improving lubrication and cooling, and generally increasing the life of the ATF.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a schematic diagram of an automatic transmission hydraulic system having a full-flow microfiltration device, according to one advantageous embodiment of the claimed invention.

FIG. 2A is a cross-sectional view of the full-flow microfiltration device shown in FIG. 1, illustrating the full-flow microfiltration device having a central chamber with a first main flow passing therethrough and a concentric chamber with a second main flow passing therethrough - a portion of the second main flow being drawn through the filter medium into the first main flow.

FIG. 2B is a cross-sectional view of the full-flow microfiltration device shown in FIG. 2A, illustrating the housing remaining sealingly coupled to the filter medium as the filter medium decompresses when the hydraulic system is halted or otherwise provides a substantially lesser flow of fluid through the full-flow microfiltration device.

FIG. 3 is a logic flow diagram of a method for operating the hydraulic system shown in FIG. 1, according to one embodiment of the present invention.

### DETAILED DESCRIPTION OF THE INVENTION

In the following figures, the same reference numerals are used to identify the same components in the various views.

The present invention is particularly suited for a full-flow microfiltration device (“filter device”) integrated within an automatic transmission hydraulic system (“hydraulic system”). However, the filtration device can be integrated within various other hydraulic systems as desired. Also, the device can instead be utilized for coarse filtration or in a parallel configuration as desired. In this regard, it will be understood that the embodiments described herein employ features where the context permits. In other words, various other embodiments without the described features are contemplated.

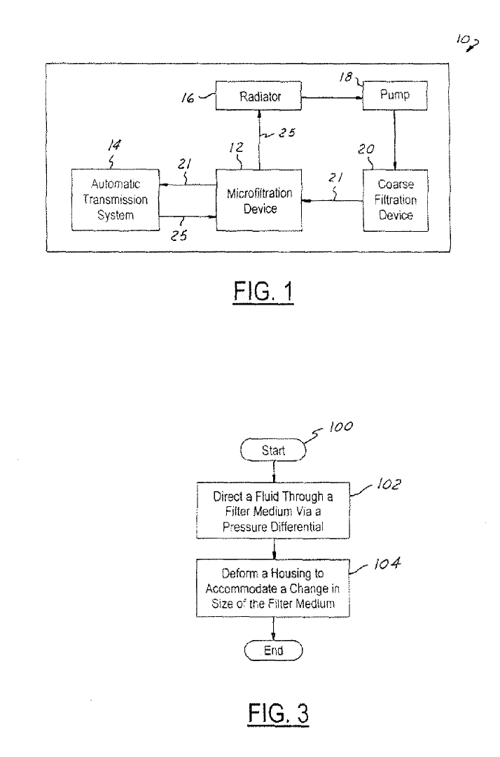

Referring to FIG. 1, there is shown a schematic diagram of a hydraulic system 10 having a full-flow filter device 12 integrated therein, according to one advantageous embodiment of the claimed invention.

This hydraulic system 10 includes an automatic transmission system 14 and utilizes automatic transmission fluid (ATF) for cooling and lubricating the automatic transmission system 14. However, it will be appreciated that the hydraulic system 10 can instead include other suitable mechanical systems, which require fluid for lubrication, cooling, various other purposes; or any combination thereof.

The automatic transmission system 14 is coupled to a conventional radiator 16 for cooling the ATF. However, it is contemplated that the hydraulic system 10 can instead include various other suitable heat exchangers as desired. Also, the automatic transmission system 14 and the radiator 16 are further operatively coupled to a pump mechanism 18 for forcing the ATF through the hydraulic system 10.

The pump mechanism 18 forces the ATF through a full-flow coarse filtration device 20, which includes a coarse filter medium. The coarse filter medium is utilized for removing solid particle contaminants having diameters greater than about 40 microns. In this way, smaller-sized particle contaminants, which have diameters up to about 40 microns, can pass through the coarse filtration device 20 and remain in the ATF. For that reason, it will be understood that the coarse filter medium has a low flow resistance.

In accordance with the claimed invention, the hydraulic system 10 further includes the full-flow microfiltration device 12 (“filter device”) coupled between the radiator 16 and the automatic transmission system 14. As detailed below, it will be appreciated that this filter device 12 provides microfiltration of a full flow of the ATF. In this regard, the filter device 12 is in a serial inline connection with the main supply line 21 and the main discharge line 23 between the radiator 16 and the automatic transmission system 14. In other words, the filter device 12 is not integrated in a parallel configuration with respect to a full flow of the ATF. This feature is beneficial because additional tubing and couplings, as well as installation time and costs associated therewith, are not required to integrate the filter device 12 into the hydraulic system 10. Also, this feature provides the hydraulic system with a compact construction and increases available space within an engine compartment.

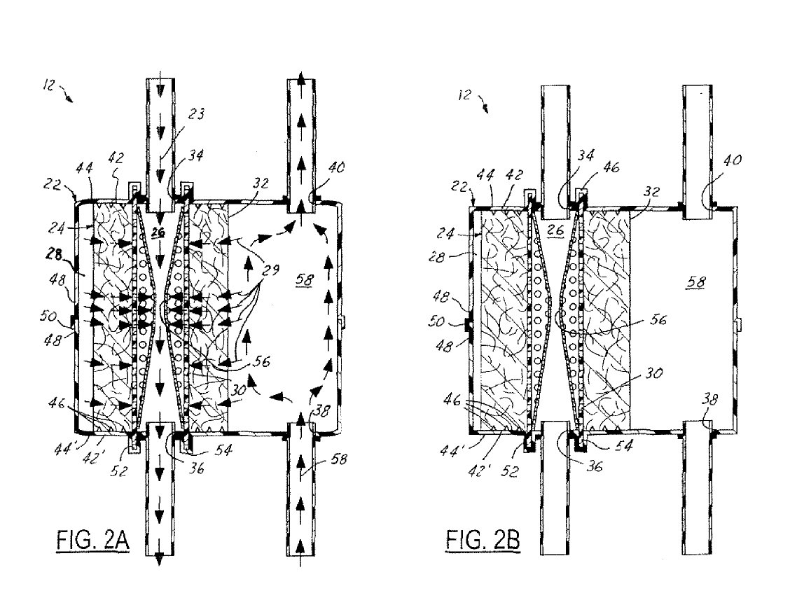

Referring now to FIGS. 2A and 2B, there are shown cross-sectional views of the filter device 12 shown in FIG. 1, according to one advantageous embodiment of the claimed invention.

FIGS. 2A and 2B generally illustrate the filter device 12 having a housing 22 and a filter medium 24 that is sealingly coupled to and contained within the housing 22. The housing 22 and the filter medium 24 define a central chamber 26 and a concentric chamber 28.

Specifically, the filter medium 24 has a perforated central core portion 30 with a high-efficiency cellulose fiber material 32 mounted thereon. The perforated central core portion 30 of the filter medium 24 defines the central chamber 26 of the filter device 12. In addition, the housing 22 and the outer periphery of the fiber material 32 define the concentric chamber 28. In this way, it will be appreciated that the filter medium 24 is disposed within the concentric chamber 28. It is contemplated that the filter medium 24 can instead have various other suitable constructions as desired.

The fiber material 32 has a substantially fine structure for removing small contaminants from the ATF. This fiber material can include paper-like material, felt-like material, glass-fiber material, electrostatic material, various other suitable materials, or any combination thereof as desired. This fiber material removes substantially small solid particles, e.g. those with diameters as low as about 5 microns. For that reason, the filter medium 24 also is highly resistant to flow therethrough. In that regard, the pressure differential across the filter medium 24 can be substantially high when the ATF passes through the filter medium 24. As detailed below, this high pressure differential can compress the filter medium 24 transversely inward thereby causing the filter medium to lengthen axially.

In this embodiment, the housing 22 has an entry port 34 and an exit port 36 formed therein. The entry port 34, the central chamber 26, and the exit port 36 are integrated within a main supply line 21 extending generally from the radiator 16 to the automatic transmission system 14. Specifically, the entry port 34 receives a first main flow 23 of ATF, which is cooled by the radiator 16. Thereafter, the first main flow 23 is directed through the central chamber 26 and through the exit port 36 to the automatic transmission system 14.

Moreover, in this embodiment, the housing 22 further includes an inlet port 38 and an outlet port 40. The inlet port 38, the concentric chamber 28, and the outlet port 40 are integrated within a main discharge line 25 extending generally from the automatic transmission system 14 to the radiator 16. In particular, the inlet port 38 receives a second main flow 27 of ATF, which is discharged from the automatic transmission system 14. The inlet port 38 is configured for directing the second main flow 27 into the concentric chamber 28 and indirectly onto the filter medium 24. In the example shown in FIGS. 2A and 2B, the inlet port 38 is configured for at least initially directing the discharged ATF 27 in an axial direction, which is parallel to the filter medium 24. For that reason, the second main flow 27 is not directly impinged upon the filter medium 24. Instead, the discharged ATF 27 fills the concentric chamber 28, surrounds the filter medium 24, and is substantially evenly distributed over the fiber material 32. Thereafter, the outlet port 40 directs a substantial portion of the second main flow 27 to the radiator 16. A pressure differential between the concentric chamber 28 and the central chamber 26 causes a portion 29 of the second main flow 27 to be drawn from the concentric chamber 28, through the filter medium 24, and into the central chamber 26 and the main supply line 21.

In one embodiment, the perforated central core portion 30 of the filter medium 24 includes a venturi tube 56 for drawing a portion 29 of the second main flow 27 from the concentric chamber 28 through the filter medium 24 into the central chamber 26 and the first main flow. As is known in the art, the venturi tube 56 operates based on the Bernoulli principle. Specifically, the venturi tube 56 is a short pipe with a constricted passage that increases the velocity and lowers the pressure of a fluid passing through it. In this way, the venturi tube 56 creates a substantial pressure differential between the central chamber 26 and the concentric chamber 28. This pressure differential can be utilized for drawing a greater portion 29 of the second main flow 27 from the concentric chamber 28 through the filter medium 24 into the central chamber 26. However, it will be appreciated that the filter device 12 can lack the venturi tube 56 and have other sufficient construction for creating a suitable pressure differential for drawing discharged ATF through the filter medium 24.

The filter medium 24 has opposing end faces 42, 42′ that are sealingly coupled to opposing end portions 44, 44′ of the housing 22. For that reason, this construction prevents the discharged ATF from circumventing the filter medium 24 by flowing from the concentric chamber 28 into the central chamber 26 via a gap between the housing 22 and the end faces 42, 42′ of the filter medium 24. In this way, the filter device 12 requires the discharged ATF to flow through the fiber material 32 of the filter medium. This feature is advantageous because the filter device 12 can remove a greater amount of contaminants from the ATF despite changes in the size of the filter medium 24.

Referring to both FIGS. 2A and 2B, the end portions 44, 44′ of the housing 22 each include three annular ribs 46 extending therefrom for pressing into and sealingly engaging the respective end faces 42, 42′ of the filter medium 24. This feature is beneficial for further preventing discharged ATF from circumventing the filter medium 24. However, it is contemplated that more or less than three annular ribs can be utilized as desired.

As best shown in FIG. 2A, in this embodiment, the opposing end portions 44, 44′ of the housing 22 are comprised of a resilient material for deforming and remaining sealingly coupled to opposing end faces 42, 42′ of the filter medium 24. In this way, the housing 22 remains sealingly coupled to the filter medium 24 when the filter medium 24 changes in axial length. This resilient material preferably is sheet metal. However, it will be appreciated that the housing 22 can instead be comprised of a variety of other suitable materials as desired.

Specifically, FIG. 2A illustrates a substantially high pressure gradient across the filter medium 24 for forcing a small portion of the ATF to flow through the fine filter medium 24. This pressure gradient can be sufficiently high for compressing the deformable filter medium 24 against its perforated central core portion 30 inwardly toward its axis. This inward compression can also cause the fiber material 32 to lengthen in a longitudinal direction. The resilient end portions 44, 44′ of the housing 22 likewise deform outwardly and remain sealingly coupled to the respective end faces 42, 42′ of the filter medium 24. The pressure gradient is produced by the pump mechanism 18 as it forces the ATF through the hydraulic system 10.

Moreover, FIG. 2B shows a substantially lower pressure gradient across the filter medium 24. One skilled in the art will understand that this low pressure gradient or lack thereof can occur when the pump mechanism 18 is turned off, e.g. when the engine of a vehicle is turned off. This lower pressure gradient allows the filter medium 24 to decompress transversely outward from the axis of the filter medium 24. This outward expansion can cause the filter medium 24 to shorten in its longitudinal direction away from the end portions 44, 44′ of the housing 22. However, these resilient end portions 44, 44′ likewise deform inwardly and remain sealingly coupled to the respective end faces 42, 42′ of the filter medium 24.

The opposing end portions 44, 44′ also each have mating portions 48, 48′ for attaching together. One or both of these mating portions 48, 48′ have a flange 50 for overlapping the other mating portion 48, 48′. This flange 50 has internal threading (not shown) formed thereon for engaging external threading (not shown) formed on the other end portion 44′. However, it will be appreciated that various other suitable fasteners can be utilized for securing the end portions 44, 44′ to each other.

Each end portion 44, 44′ of the housing 22 has a self-locating groove 52 formed therein for receiving a self-locating protrusion 54 that extends from the center core portion 30 of the filter medium 24. The self-locating groove 52 preferably receives the entire length of the self-locating protrusion 54 for allowing the end faces 42, 42′ of the filter medium 24 to sealingly engage the end portions 44, 44′ of the housing 22. This construction positions the filter medium 24 in the concentric chamber 28 for immersing the entire periphery of the filter medium 24 in the discharged ATF. However, it is understood that the self-locating groove 25 can instead receive other suitable lengths of the self-locating protrusion 54 as desired. In addition, it is contemplated that the self-locating groove 52 and the self-locating protrusion 54 can be utilized for locating the filter medium 24 in other suitable positions as desired.

In this embodiment, the concentric chamber 28 extends across an axial length of the housing 22. Also, the housing 22 includes a bulged-out portion 58 as taken from an axial view. This bulged out portion 58 defines an enlarged portion of the concentric chamber 28 and contains the discharged ATF. However, it is contemplated that the concentric chamber 28 can have various other suitable constructions as desired.

Referring now to FIG. 3, there is shown a logic flow diagram of a method for operating the hydraulic system 10 shown in FIG. 1. The method begins in step 100 and immediately proceeds to step 102.

In step 102, the ATF is pumped through the closed-loop hydraulic system 10 and specifically through the filter medium 24 of the filter device 12. This step is initiated by activating the pump mechanism 18 of the hydraulic system 10. In so doing, a first main flow 23 of the ATF is directed from the entry port 34 of the filter device 12 through the central chamber 26 to the exit port 36. This first main flow 23 originates from the radiator 16 and therefore includes cooled ATF. In addition, a second main flow 27 of the ATF flows from the inlet port 38 of the filter device 12 through the concentric chamber 28 to the outlet port 40. This second main flow 27 of ATF comes from the automatic transmission system 14 and can therefore include solid particle contaminants from system component wear and various other debris. As shown in FIG. 2A, the ATF in the first and second main flows 23, 27 are separated by the filter medium.

The ATF in the first main flow 23 has a substantially lower pressure than the ATF in the second main flow 27. In this regard, a portion 29 of the discharged ATF in the second main flow 27 is drawn from the concentric chamber 28 through the filter medium 24 into the central chamber 26. In one embodiment, the central chamber 26 of the filter medium 24 has a venturi tube 56 disposed therein for substantially decreasing the pressure of the ATF in the first flow 23. For that reason, the pressure differential can substantially increase from the concentric chamber 28 to the central chamber 26. This substantial pressure differential is beneficial because a greater portion 29 of the discharged ATF 27 can be drawn from the concentric chamber 28 through the filter medium 24 and be cleaned.

In addition, it will also be appreciated that the substantial pressure differential across the filter medium 24 can compress the deformable filter medium 24. Specifically, the filter medium 24 can be compressed transversely inward toward the central chamber 26. As a result, the filter medium 24 can simultaneously lengthen in a longitudinal direction. The sequence then proceeds to step 104.

In step 104, the resilient housing 22 deforms to accommodate for the change in size of the filter medium 24 and maintain a sealing engagement between the filter medium 24 and the housing 22. Specifically, the housing 22 has two end portions 44, 44′ which are comprised of resilient material, e.g. sheet metal. Also, both of these end portions 44, 44′ are sealingly coupled to the filter medium 24. As shown in FIG. 2A, the resilient end portions 44, 44′ deform outward when the filter medium 24 lengthens in a longitudinal direction. Also, the resilient end portions 44, 44′ deform inward when the filter medium shortens in the longitudinal direction. In this way, the resilient end portions of the housing 22 remain sealingly coupled to the filter medium 24 despite changes in the size of the filter medium.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

1. A full-flow microfiltration device for filtering a fluid in a hydraulic system, comprising:
a housing;
a filter medium contained within said housing and sealingly coupled to said housing for defining a central chamber and a concentric chamber, said filter medium separating said central chamber from said concentric chamber;
wherein said housing has an entry port and an exit port integrated therein that are in direct communication with said central chamber, said entry port, said central chamber, and said exit port for directing a first flow through the full-flow microfiltration device;
wherein said housing further includes an inlet port and an outlet port integrated therein that are in direct communication with said concentric chamber, said inlet port, said concentric chamber, and said outlet port for directing a second flow through the full-flow microfiltration device;
wherein a filtered portion of said second main flow is drawn from said concentric chamber through said filter medium into said central chamber and into said first flow.

2. The full-flow microfiltration device recited in claim 1 wherein said entry port and said exit port are coupled to a first pair of main flow lines, said inlet port and said exit port being coupled to a second pair of main flow lines.

3. The full-flow microfiltration device recited in claim 1 wherein said inlet port is configured for directing said second flow into said concentric chamber and indirectly onto said filter medium.

4. The full-flow microfiltration device recited in claim 1 wherein said filter medium has a pair of opposing end faces that are sealingly coupled to a pair of opposing ends of said housing.

5. The full-flow microfiltration device recited in claim 4 wherein at least one of said pair of opposing end portions has at least one annular rib extending therefrom for contacting said filter medium in a sealing engagement.

6. The full-flow microfiltration device recited in claim 4 wherein said opposing ends of said housing is comprised of a resilient material for deforming and remaining sealingly coupled to said filter medium.

7. The full-flow microfiltration device recited in claim 1 wherein said filter medium includes a venturi tube for decreasing pressure in said central chamber and drawing the fluid from said concentric chamber through said filter medium into said central chamber.

8. The full-flow microfiltration device recited in claim 1 wherein said housing includes a bulged-out portion defining an enlarged portion of said concentric chamber.

9. The full-flow microfiltration device recited in claim 1 wherein said concentric chamber extends across an axial length of said housing.

10. The full-flow microfiltration device recited in claim 1 wherein said housing has a substantially cylindrical construction.

11. The full-flow microfiltration device recited in claim 1 wherein said housing is comprised of sheet metal.

12. The full-flow microfiltration device recited in claim 1 wherein one of said opposing end portions of said housing has a flange for attachment to the other of said opposing end portions.

13. The full-flow microfiltration device recited in claim 1 wherein said filter medium has a self-locating protrusion extending therefrom for engaging the housing and positioning said filter medium in a predetermined position within said housing.

14. The full-flow microfiltration device recited in claim 13 wherein said housing has a self-locating groove formed therein for receiving said self-locating protrusion and positioning said filter medium in said predetermined position.

15. An automatic transmission hydraulic system utilizing a fluid for lubrication and heat transfer, comprising:
a heat exchanger for cooling the fluid;
an automatic transmission system; and
a full-flow microfiltration device coupled between said heat exchanger and said automatic transmission system, said full-flow microfiltration device for passing a main supply flow and a main discharge flow therethrough;
wherein said full-flow microfiltration device includes a housing and a filter medium contained within said housing, said filter medium being sealingly coupled to said housing for defining a central chamber and a concentric chamber, said filter medium separating said central chamber from said concentric chamber.

16. The automatic transmission hydraulic system recited in claim 15 wherein said entry port and said exit port are coupled to a pair of main supply lines for supplying the fluid from said heat exchanger to said automatic transmission system, said inlet port and said exit port being coupled to a pair of main discharge lines for discharging the fluid from said automatic transmission system to said heat exchanger.

17. The full-flow microfiltration device recited in claim 15 wherein said inlet port is configured for directing said second flow into said concentric chamber and indirectly onto said filter medium.

18. A method for filtering a fluid in a hydraulic system, comprising:
directing a first flow of the fluid through a central chamber of a full-flow microfiltration device;
directing a second flow of the fluid through a concentric chamber of said full-flow microfiltration device; directing a portion of said second flow from said concentric chamber through a filter medium into said central chamber.

19. The method recited in claim 18 wherein directing said portion of said second flow comprises:
decreasing a fluid pressure within a venturi tube that is adjacent to said filter medium.

20. The method recited in claim 18 further comprising:
changing a size of said filter medium; and
deforming at least one resilient end portion of a housing for maintaining said filter medium sealingly coupled to said housing.
